(19) United States
(12) Patent Application Publication
(10) Pub. No.: US 2023/0069628 A1
(43) Pub. Date: Mar. 2, 2023

(54) EXTERNAL LANGUAGE MODEL FUSING METHOD FOR SPEECH RECOGNITION

(71) Applicant: INTERNATIONAL BUSINESS MACHINES CORPORATION, Armonk, NY (US)

(72) Inventors: Tohru Nagano, Taito-Ku (JP); Masayuki Suzuki, Tokyo (JP); Gakuto Kurata, Tokyo (JP)

(21) Appl. No.: 17/410,347

(22) Filed: Aug. 24, 2021

(51) Int. Cl. G06K 9/62; G06N 3/04

(52) U.S. Cl. CPC G06K 9/6288; G06K 9/6298; G06N 3/0481

(57) ABSTRACT

A computer-implemented method for fusing an end-to-end speech recognition model with an external language model (ExternalLM) is provided. The method includes obtaining an output of the end-to-end speech recognition model. The output is a probability distribution. The method further includes transforming, by a hardware processor, the probability distribution into a transformed probability distribution to relax a sharpness of the probability distribution. The method also includes fusing the transformed probability distribution and a probability distribution of the ExternalLM for decoding speech.

### BACKGROUND

The present invention generally relates to speech recognition, and more particularly to an external language model fusing method for end-to-end speech recognition.

An end-to-end speech recognition system directly maps a sequence of input acoustic features into a sequence of grapheme or words. Recurrent neural network transducer (RNN-T) architectures have become a trend in speech recognition because they have the advantage of being much faster than other end-to-end architectures. Since an RNN-T architecture has no explicit language models, fusing an external language model (ExternalLM) with an RNN-T is mandatory for adapting new topics. However, the probability distribution over output symbols (alphabet) is quite peaky, making the effective fusion of the RNN-T output and the ExternalLM difficult.

### SUMMARY

According to aspects of the present invention, a computer-implemented method for fusing an end-to-end speech recognition model with an external language model (ExternalLM) is provided. The method includes obtaining an output of the end-to-end speech recognition model. The output is a probability distribution. The method further includes transforming, by a hardware processor, the probability distribution into a transformed probability distribution to relax a sharpness of the probability distribution. The method also includes fusing the transformed probability distribution and a probability distribution of the ExternalLM for decoding speech.

According to other aspects of the present invention, a computer program product for fusing an end-to-end speech recognition model with an external language model (ExternalLM) is provided. The computer program product includes a non-transitory computer readable storage medium having program instructions embodied therewith. The program instructions are executable by a computer to cause the computer to perform a method. The method includes obtaining, by a hardware processor, an output of the end-to-end speech recognition model. The output is a probability distribution. The method further includes transforming, by the hardware processor, the probability distribution into a transformed probability distribution to relax a sharpness of the probability distribution. The method also includes fusing, by the hardware processor, the transformed probability distribution and a probability distribution of the ExternalLM for decoding speech.

According to yet other aspects of the present invention, a computer processing system is provided for fusing an end-to-end speech recognition model with an external language model (ExternalLM). The computer processing system includes a memory device for storing program code. The computer processing system further includes a hardware processor operatively coupled to the memory device for running the program code to obtain an output of the end-to-end speech recognition model. The output is a probability distribution. The hardware processor further runs the program code to transform the probability distribution into a transformed probability distribution to relax a sharpness of the probability distribution. The hardware processor also runs the program code to fuse the transformed probability distribution and a probability distribution of the ExternalLM for decoding speech.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary computing device, in accordance with an embodiment of the present invention;

FIG. 2 is a block diagram showing an exemplary speech recognition architecture, in accordance with an embodiment of the present invention;

FIG. 3 is an output of the RNN-T model of FIG. 2 showing an exemplary speech recognition alphabet and corresponding probabilities, in accordance with an embodiment of the present invention;

FIG. 4 is a flow diagram showing an exemplary method for fusing an end-to-end speech recognition model with an external language model (ExternalLM), in accordance with an embodiment of the present invention.

FIG. 5 shows an exemplary operating environment, in accordance with an embodiment of the present principles;

FIG. 6 is a block diagram showing an illustrative cloud computing environment having one or more cloud computing nodes with which local computing devices used by cloud consumers communicate, in accordance with an embodiment of the present invention; and

FIG. 7 is a block diagram showing a set of functional abstraction layers provided by a cloud computing environment, in accordance with an embodiment of the present invention.

### DETAILED DESCRIPTION

Embodiments of the present invention are directed to an external language model fusing method for end-to-end speech recognition.

As noted above, Recurrent Neural Network Transducer (RNN-T) architectures lack explicit language models, requiring fusing such explicit language models to the RNN-T under the undesirable condition that the probability distribution over output symbols is quite peaky.

Embodiments of the present invention transform a probability distribution of a RNN-T output by a non-linear function to relax the sharpness (peaks) of the probability distribution. In this way, the transformed probability distribution having the relaxed sharpness can be used as the output of an end-to-end speech recognition system. As used herein, the term “relaxed sharpness” refers to reducing the peakiness of a probability output by distorting the probability distribution and lowering the amplitudes of higher probability. In embodiments of the present invention, the non-linear function used to relax the sharpness can be log( ) or pow( ). In embodiments of the present invention, parameters can be derived from the probability distribution of the external language model (ExternalLM).

Embodiments of the present invention use a max( ) function to search the best output sequence. For example, in an embodiment, a softmax function can be used.

In an embodiment, the fusing method can be provided as a cloud service. In an embodiment, the end-to-end speech recognition system is hosted in the cloud and is accessible via stationary and/or mobile computing devices.

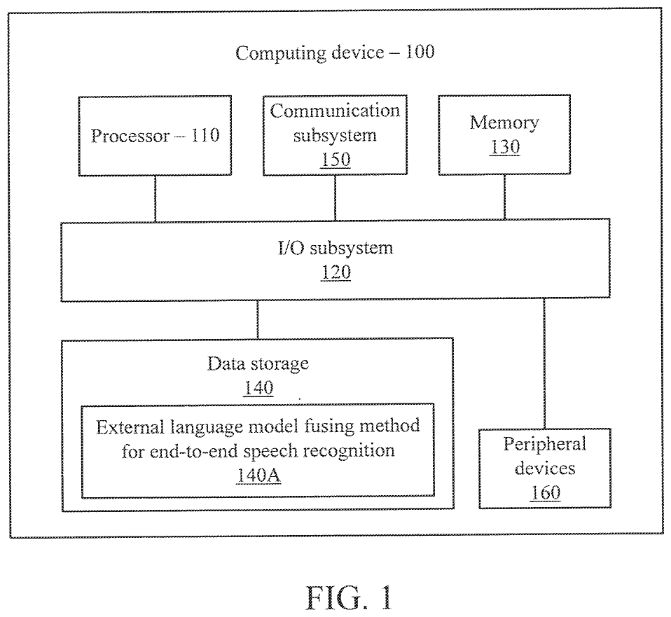

FIG. 1 is a block diagram showing an exemplary computing device 100, in accordance with an embodiment of the present invention. The computing device 100 is configured to perform external language model fusing for end-to-end speech recognition.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for external language model fusing for end-to-end speech recognition. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

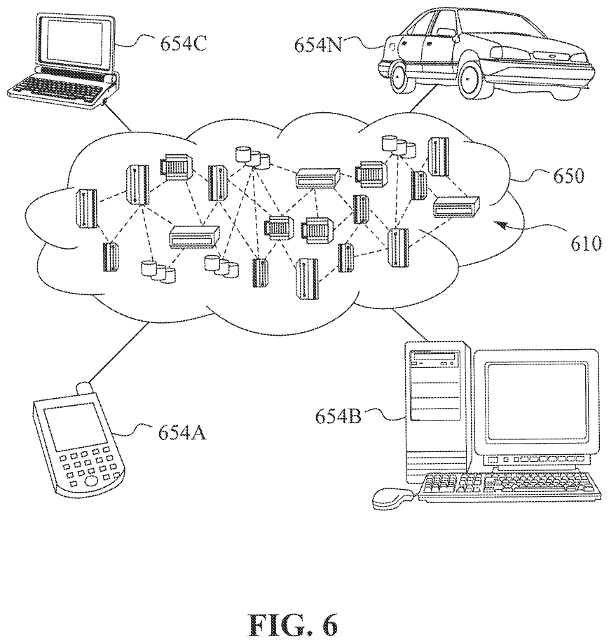

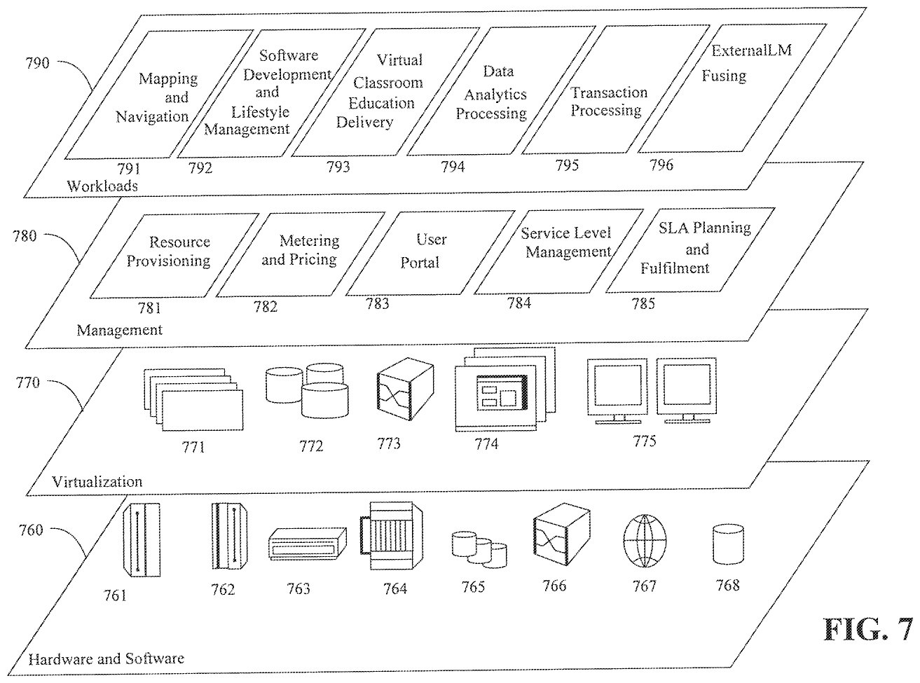

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used (e.g., see FIGS. 6-7). These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

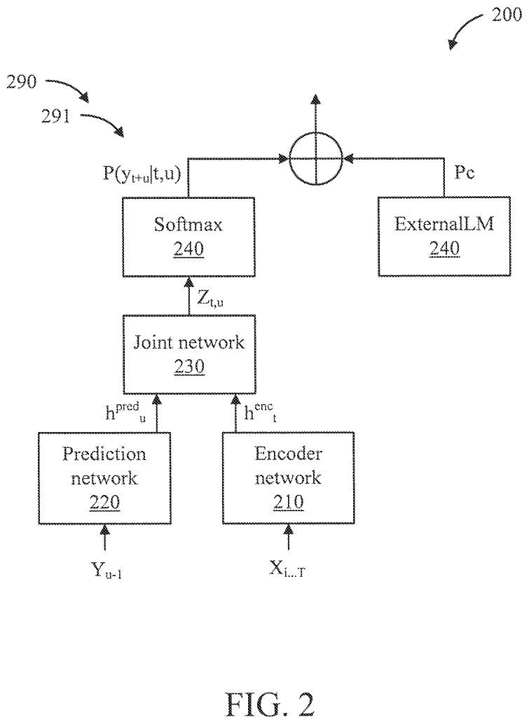

FIG. 2 is a block diagram showing an exemplary speech recognition architecture 200, in accordance with an embodiment of the present invention.

The speech recognition architecture 200 includes an encoder network 210, a prediction network 220, a joint network 230, a softmax block 240, an ExternalLM 250, and a combiner 260. The prediction network 220, joint block 230, and softmax block 240 can be considered to form a decoder network 290. The softmax block 240 can be considered as at least a part of Recurrent Neural Network Transducer (RNN-T) model 291.

The encoder network 210 serves as an acoustic model to convert the input features to an embedding vector sequence with the input frame length. The prediction network 220 works as a language model to produce an embedding with conditioning on the previous predictions. The joint network 230 outputs an embedding by combining the output from the encoder network 210 and the output from the prediction network 220.

The prediction network 220 takes Yᵤ₋₁ as input, and outputs h^{pred}ᵤ.

The encoder 210 takes X_{i . . . T} as input, and outputs h^{enc}ₜ.

The joint block 230 takes h^{pred}ᵤ and h^{enc}ₜ as inputs, and outputs Z_{t,u}.

The softmax block 240 takes Z_{t,u} as input, and outputs P(yₜ₊ᵤ|t,u).

The ExternalLM 250 outputs Pc.

The combiner 260 takes P(yₜ₊ᵤ|t,u) and Pc as inputs and outputs y*=argmax_{y} log P(y|x)+λ log P_{c}(y).

The biggest limitation of using the RNN-T 291 is the need for voice and text pair that is costly and time consuming to collect when training the model. The fusion with an external language model trained separately at decoding time is a method for utilizing unpaired text data. The fusion interpolates the probability from the RNN-T model and the probability from ExternalLM.

In FIG. 2, the following notations apply:

X_{i . . . T} denotes an i-th input feature of an acoustic sequence, with T denoting a sequence length (X: x₁ . . . x_{T});

denotes predicted output character symbols;

h^{enc}ₜ denotes an embedding vector sequence of an input feature;

h^{pred}ᵤ denotes an embedding with conditioning on the previous predictions;

Z_{t,u} denotes an embedding of the joint network 230 by combing the output from the prediction network 220 and the output from the encoder network 210;

Pc denotes a probability of characters of the ExternalLM;

P(yₜ₊ᵤ|t,u) denotes a posterior distribution over the set of characters; and

y*=argmax_{y} log P(y|x)+λ log P_{c}(y) denotes an interpolated probability from the RNN-T model and the probability from the ExternalLM, log P(y|x) denotes the portion of the probability corresponding to the RNN-T model 291, and λ log P_{c}(y) corresponds to the ExternalLM.

However, while the probability distribution of RNN-T is very peaked, the shapes of the probability distributions output from the RNN-T model and the ExternalLM are very different. To alleviate this gap, the present invention distorts the probability distribution to suppress peaky probability from the RNN-T to improve accuracy when decoding with the ExternalLM.

An embodiment of the present invention transforms the output of the softmax block 240 in the RNN-T 291 by a non-linear function and uses the mapped probability instead of the original softmax output P(yᵢ)=softmax(zᵢ) as follows:

P′(yᵢ)=softmax(γ log softmax(zᵢ))

For decoding, when searching for the best path, the score is defined as the summation of symbol posterior probabilities over all possible RNN-T alignments which have same output symbol sequences as follow:

P(y|x)=Σ_{a∈B(y)}p(a|x)

An alignment is the sequence a=(a₁, . . . a_{T+U}) where the element aᵢ belongs to the augmented output space. The mapping B strips the blank symbols from a such that B(a)=y.

The present invention can use the maximum value instead of a summation to evaluate the skewed score as follows:

p(y|x)=max_{a∈B(y)}p(a|x)

The parameter y is a hyper parameter to control the magnitude of the amplitude of the distribution and can be determined by: (i) grid search using held-out data; and (ii) statistics of the probability distribution of the ExternalLM (e.g., average mean, variance, kurtosis, and skewness). Held-out data is data used only for training (and not testing).

In an embodiment, non-linear function for distorting probability distribution from RNN-T may be determined by statistics of the output of ExternalLM

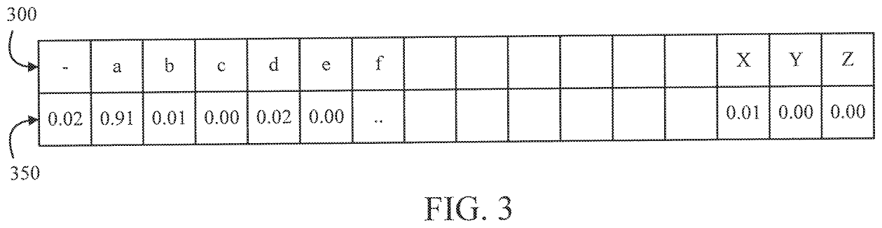

FIG. 3 is an output of the RNN-T model 291 of FIG. 2 showing an exemplary speech recognition alphabet 300 and corresponding probabilities 350, in accordance with an embodiment of the present invention.

The speech recognition alphabet 300 includes character “a” through character “z” and character “A” through character “Z” (noting that not all characters are shown). In the example of FIG. 2, the alphabet character having the highest probability of 0.91 is alphabet character “a”.

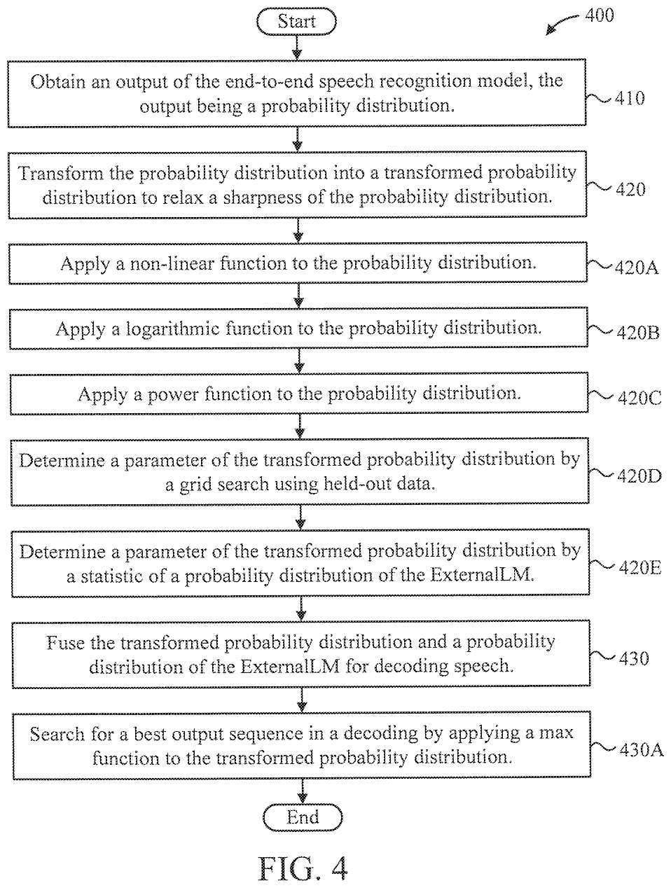

FIG. 4 is a flow diagram showing an exemplary method 400 for fusing an end-to-end speech recognition model with an external language model (ExternalLM), in accordance with an embodiment of the present invention.

At block 410, obtain an output of the end-to-end speech recognition model, the output being a probability distribution.

At block 420, transform the probability distribution into a transformed probability distribution to relax a sharpness of the probability distribution. This step reduces the amplitudes of the peaks of the probability distribution to enable subsequent fusing of the transformed probability distribution with the probability distribution of the ExternalLM. This step can involve reducing one or more amplitudes of the probability distribution which are greater than a threshold amount and/or reducing one or more amplitudes of the probability distribution by a threshold amount.

In an embodiment, block 420 can include one or more of blocks 420A through 420E.

At block 420A, apply a non-linear function to the probability distribution.

At block 420B, apply a logarithmic function to the probability distribution. A logarithmic function is an example of a non-linear function.

At block 420C, apply a power function to the probability distribution. A power function is an example of a non-linear function.

At block 420D, determine a parameter of the transformed probability distribution by a grid search using held-out data.

At block 420E, determine a parameter of the transformed probability distribution by a statistic of a probability distribution of the ExternalLM.

At block 430, fuse the transformed probability distribution and a probability distribution of the ExternalLM for decoding speech.

In an embodiment, block 430 can include block 430A.

At block 430A, search for a best output sequence in a decoding by applying a max function to the transformed probability distribution.

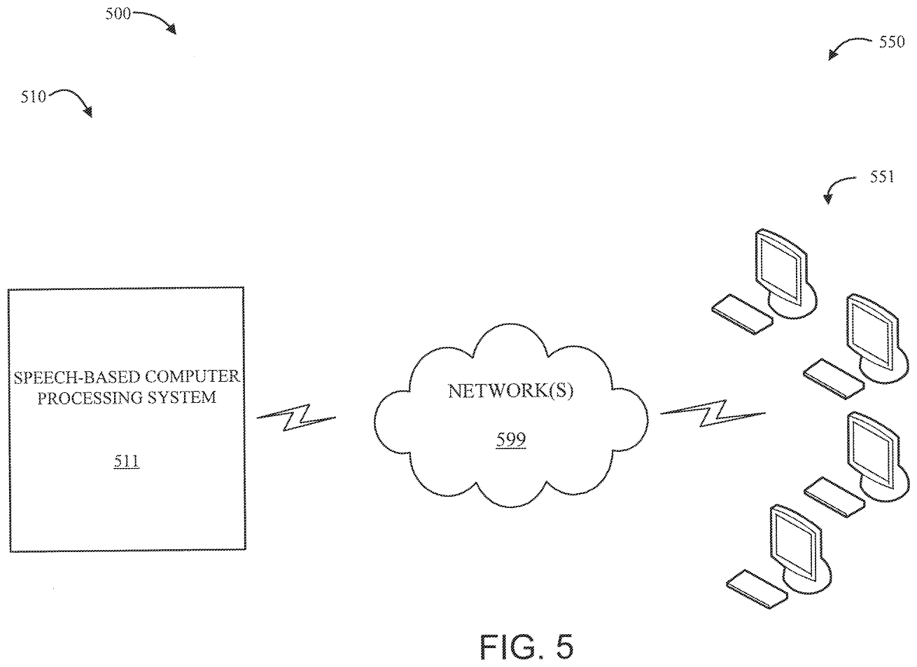

FIG. 5 shows an exemplary operating environment 500, in accordance with an embodiment of the present principles.

The environment 500 involves a server side 510 and a client side 550.

The server side 510 includes a speech-based computer processing system. For illustrative purposes, the speech-based computer processing system is an end-to-end speech recognition system 511. The end-to-end speech recognition system 511 has improved speech recognition accuracy in accordance with the present principles. It is to be appreciated that block 511 can represent any speech-based computer processing system that involves one or more of the following: speech recognition; speaker identification; speaker verification; speaker diarisation; language identification; keyword spotting; emotion detection; automatic translation; court reporting; hands-free computing; home automation; mobile telephony; and so forth.

The client side 550 includes a set of workstations 551.

Users at the workstations 551 can engage in and/or otherwise use speech recognition sessions. The speech recognition sessions can relate, but are not limited to, customer service, voice dialing, machine control, data searching, data entry, system/facility/entity access, and so forth.

Communications between the server side 510 and the client side 550 are made through one or more networks 599. In an embodiment, the server side 510 is realized using a cloud configuration.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 650 is depicted. As shown, cloud computing environment 650 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 6 are intended to be illustrative only and that computing nodes 610 and cloud computing environment 650 can communicate with any type of computerized device over any type of network and/or network addressable connection (e.g., using a web browser).

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 884 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and external language model (ExternalLM) fusing for end-to-end speech recognition 796.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for fusing an end-to-end speech recognition model with an external language model (ExternalLM), the method comprising:
obtaining an output of the end-to-end speech recognition model, the output being a probability distribution;
transforming, by a hardware processor, the probability distribution into a transformed probability distribution to relax a sharpness of the probability distribution; and
fusing the transformed probability distribution and a probability distribution of the ExternalLM for decoding speech.

2. The computer-implemented method of claim 1, wherein the fusing comprising searching for a best output sequence in a decoding by applying a max function to the transformed probability distribution.

3. The computer-implemented method of claim 1, wherein the transforming is performed by applying a non-linear function to the probability distribution.

4. The computer-implemented method of claim 1, wherein the transforming is performed by applying a logarithmic function to the probability distribution.

5. The computer-implemented method of claim 1, wherein the transforming is performed by applying a power function to the probability distribution.

6. The computer-implemented method of claim 1, wherein the transformed probability distribution comprises a probability distribution amplitude controlling hyper parameter determined by a grid search using held-out data.

7. The computer-implemented method of claim 1, wherein the transformed probability distribution comprises a probability distribution amplitude controlling hyper parameter determined by a statistic of a probability distribution of the ExternalLM.

8. The computer-implemented method of claim 1, wherein the sharpness of the probability distribution is relaxed by reducing one or more amplitudes of the probability distribution which are greater than a threshold amount.

9. The computer-implemented method of claim 1, wherein the sharpness of the probability distribution is relaxed by reducing one or more amplitudes of the probability distribution by a threshold amount.

10. A computer program product for fusing an end-to-end speech recognition model with an external language model (ExternalLM), the computer program product comprising a non-transitory computer readable storage medium having program instructions embodied therewith, the program instructions executable by a computer to cause the computer to perform a method comprising:
obtaining, by a hardware processor, an output of the end-to-end speech recognition model, the output being a probability distribution;
transforming, by the hardware processor, the probability distribution into a transformed probability distribution to relax a sharpness of the probability distribution; and
fusing, by the hardware processor, the transformed probability distribution and a probability distribution of the ExternalLM for decoding speech.

11. The computer program product of claim 10, wherein the fusing comprising searching for a best output sequence in a decoding by applying a max function to the transformed probability distribution.

12. The computer program product of claim 10, wherein the transforming is performed by applying a non-linear function to the probability distribution.

13. The computer program product of claim 10, wherein the transforming is performed by applying a logarithmic function to the probability distribution.

14. The computer program product of claim 10, wherein the transforming is performed by applying a power function to the probability distribution.

15. The computer program product of claim 10, wherein the transformed probability distribution comprises a probability distribution amplitude controlling parameter hyper parameter determined by a grid search using held-out data.

16. The computer program product of claim 10, wherein the transformed probability distribution comprises a probability distribution amplitude controlling parameter hyper parameter determined by a statistic of a probability distribution of the ExternalLM.

17. The computer program product of claim 10, wherein the sharpness of the probability distribution is relaxed by reducing one or more amplitudes of the probability distribution which are greater than a threshold amount.

18. The computer program product of claim 10, wherein the sharpness of the probability distribution is relaxed by reducing one or more amplitudes of the probability distribution by a threshold amount.

19. A computer processing system for fusing an end-to-end speech recognition model with an external language model (ExternalLM), the computer processing system comprising:
a memory device for storing program code; and
a hardware processor operatively coupled to the memory device for running the program code to
obtain an output of the end-to-end speech recognition model, the output being a probability distribution;
transform the probability distribution into a transformed probability distribution to relax a sharpness of the probability distribution; and
fuse the transformed probability distribution and a probability distribution of the ExternalLM for decoding speech.

20. The computer processing system of claim 19, wherein the fusing comprising searching for a best output sequence in a decoding by applying a max function to the transformed probability distribution.
